(19) United States
(12) Patent Application Publication
(10) Pub. No.: US 2010/0037517 A1
(43) Pub. Date: Feb. 18, 2010

(54) Plant Cultivation Apparatus with Open Channel Irrigation System

(75) Inventors: David Alexander James Copping, Karrinyup (AU); Christopher Neill Martin, Sorrento (AU); Richard Hardman, Winthrop (AU)

Correspondence Address: EDELL, SHAPIRO & FINNAN, LLC, 1901 RESEARCH BOULEVARD, SUITE 400, ROCKVILLE, MD, 20850, US

(73) Assignee: CLEV-A-GARDEN PTY LTD, Belmont (AU)

(21) Appl. No.: 12/199,969

(22) Filed: Aug. 28, 2008

Related U.S. Application Data
(63) Continuation of application No. PCT/AU2007/000221, filed on Feb. 28, 2007.

(30) Foreign Application Priority Data
Feb. 28, 2006 (AU) 2006900989

(51) Int. Cl. A01G 25/00; A01G 9/02

(52) U.S. Cl. 47/79; 47/65.5; 47/83

(57) ABSTRACT

A plant cultivation apparatus includes a housing with at least one receptacle arranged to receive and support a corresponding number of plants and at least one conduit attached to the housing connecting each of the receptacles with a reservoir such that at least a portion of each conduit is open to the atmosphere.

### CROSS-REFERENCE TO RELATED APPLICATIONS

This application is a continuation of International Application No. PCT/AU2007/000221, filed Feb. 28, 2007, and entitled “Plant Cultivation Apparatus With Open Channel Irrigation System,” which claims priority to Australian Patent Application No. 2006900989, filed on Feb. 28, 2006, the entire contents of each of which are hereby incorporated by reference.

### FIELD

The invention relates to a plant cultivation apparatus with an open channel irrigation system. The invention is particularly suited to cultivating multiple plants in the same apparatus.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

System for cultivating a plurality of plants in close proximity are commonly termed “plant cultivation apparatus” or “planter” and such planters are arranged to allow as many plants as possible to be cultivated per unit area of land compared with traditional cultivation methods. Such planters generally comprise a rack having an upwardly extending support frame presenting apertures into which plant pots holding individual plants are inserted. These apertures are conveniently arranged in any array so that the plants are in effect stacked in a plane substantially more than 45° to the horizontal—sometimes even substantially vertically. The overall effect is the appearance of a wall of plants.

Some prior art planters include a reservoir and an irrigation system for distributing water from the reservoir for individual plants. It is known to distribute water from the reservoirs to individual plants using micro-sprays arranged inside the plant cultivation apparatus housing. It is also known to feed water to individual plants using tubes that are referred to in the art as “drippers”.

Drippers have enclosed passageways, typically small in diameter, for regulating the water which they deliver. These are prone to clogging, through the accumulation of scale or build-ups of other precipitates—even from the nutrients and fertilisers which are added to the water to promote plant development and health. When drippers become partially blocked, the pressure differential in the system caused by the block results in those plants fed by the portion of the system between the water feed and the block receiving greater water than those plants fed by the remainder of the system. Furthermore, it is also difficult, if not impractical to clean the drippers and the conduits leading to them due to their enclosed nature.

It is therefore an object of the present invention to overcome, at least in part, some or all of the aforementioned problems

### SUMMARY

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is a plant cultivation apparatus comprising:
a housing having a plurality of receptacles arranged to receive and support a corresponding plurality of plants;
at least one conduit attached to the housing connecting each of the receptacles with a reservoir; and
   wherein at least a portion of each conduit is open to the atmosphere.

Each conduit has a length defined as the length of the conduit between the receptacle and the reservoir. Preferably, the portion of the conduit open to the atmosphere represents at least half the length of the conduit (on a sum total basis). Ideally, the full length of the conduit is open to the atmosphere.

The at least one conduit may include one or more banked arcuate portions. The banked arcuate portion may project from a front face of the housing or be flush therewith. Alternatively, the at least one conduit may include one or more arcuate portions, each arcuate portion closed to the atmosphere

Each plant receptacle preferably has an open end and a root end. The plant receptacle is best positioned in a downwardly inclined manner such that the root end is lower than the open end in normal orientation of the plant cultivation apparatus. The root end may have drainage holes provided therein to assist self drainage of the receptacle. In a further preferred embodiment, the housing includes at least one aperture into which a plant receptacle may be detachably received.

The root end of each plant receptacle may also be permeable to liquids.

The housing can be made impermeable to moisture. This allows the housing to better withstand the rigours of a humid environment.

The housing may comprise a plurality of interconnecting, detachable segments. To facilitate correct orientation and connection of each detachable segment, a portion of an alignment groove may be inscribed on each segment, correct connection and orientation of the detachable segments only being achieved when the portions of the alignment groove combined to form a contiguous line. The housing may operate as a floor standing unit or may be adapted to be wall-mounted.

The use of interconnecting, detachable segments allows the plant cultivation apparatus to be disassembled for ease of relocation or storage.

Ideally, at the point of connection between a first lower segment and a second upper segment, a portion of the conduit provided in the first lower segment at the point of interconnection has an expanded cross-section relative to the remainder of the conduit. In this manner, slight imperfections in the alignment of the segments will result in minimal loss of fluid as it flows from one segment to the next.

To provide strength to the plant cultivation apparatus, the housing preferably includes an at least partially convex face.

A shallow trough may be installed between the conduit and the plant receptacle. The shallow trough operates to fan out the fluid as it is delivered by the conduit and thereby assist in dispersement of the fluid to the plant receptacle.

The conduit may have a variety of cross-sections. In those cross-sections that provide for a base and side walls, the base may have a smooth profile and the side walls may have a rough profile. Alternatively, the base may have a rough profile and the side walls may have a smooth profile. This combination of smooth/rough profiles allows the fluid to be directed in accordance with the general understanding of surface tension principles. Ideally, for manufacturing efficiencies, the conduit has a “V”-shaped cross-section.

Ideally, gravity is used to move fluid along the conduit from the reservoir to each plant receptacle.

In accordance with a second aspect of the present invention, there is a plant cultivation system according to the first aspect of the invention adapted to work in unison with a water feed apparatus. The water feed apparatus comprises at least one fluid reservoir and at least one dispenser. The water feed apparatus is positioned relative to the plant cultivation apparatus such that each dispenser is operable to dispense fluid from the fluid reservoir to at least one of the reservoirs.

The plant cultivation system may include a sump to collect fluid that drains from the receptacles. The sump may further be configured to recycle the fluid back to the fluid reservoir.

The plant cultivation system may further include a heater. The heater may be positioned so as to heat the fluid in either the reservoir or the fluid reservoir. Alternatively, the heater may be positioned so as to increase the general humidity surrounding the plant cultivation apparatus.

### BRIEF DESCRIPTION OF THE DRAWINGS

The invention will now be described, by way of example only, with reference to the accompanying drawings, in which:

FIG. 1 is a perspective view of a first embodiment of a plant cultivation apparatus according to the invention.

FIG. 2 is a close-up view of two of the receptacles of the apparatus of FIG. 1 showing the profile of two conduits, each conduit feeding an associated receptacle.

FIG. 3 is an exploded view of a second embodiment of a plant cultivation apparatus according to the invention.

FIGS. 4a to 4e illustrates various cross-sectional profiles that the conduits may take.

FIG. 5 is a partial cross-sectional view of the both embodiments of the invention incorporating a plant and a water feed apparatus.

### DETAILED DESCRIPTION

Particular embodiments of the present invention will now be described with reference to the accompany drawings. The terminology used herein is for the purpose of describing particular embodiments only and is not intended to limit the scope of the present invention. Additionally, unless defined otherwise, all technical and scientific terms used herein have the same meanings as commonly understood by one or ordinary skill in the art to which this invention belongs.

In accordance with a first embodiment of the present invention there is a plant cultivation apparatus 10. The plant cultivation apparatus 10, comprises:
A housing 12; and
A water feed apparatus 14.

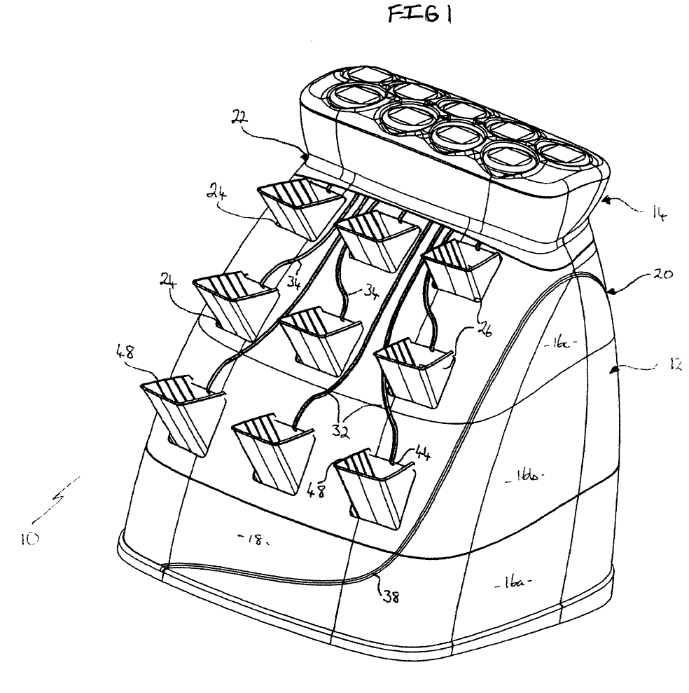

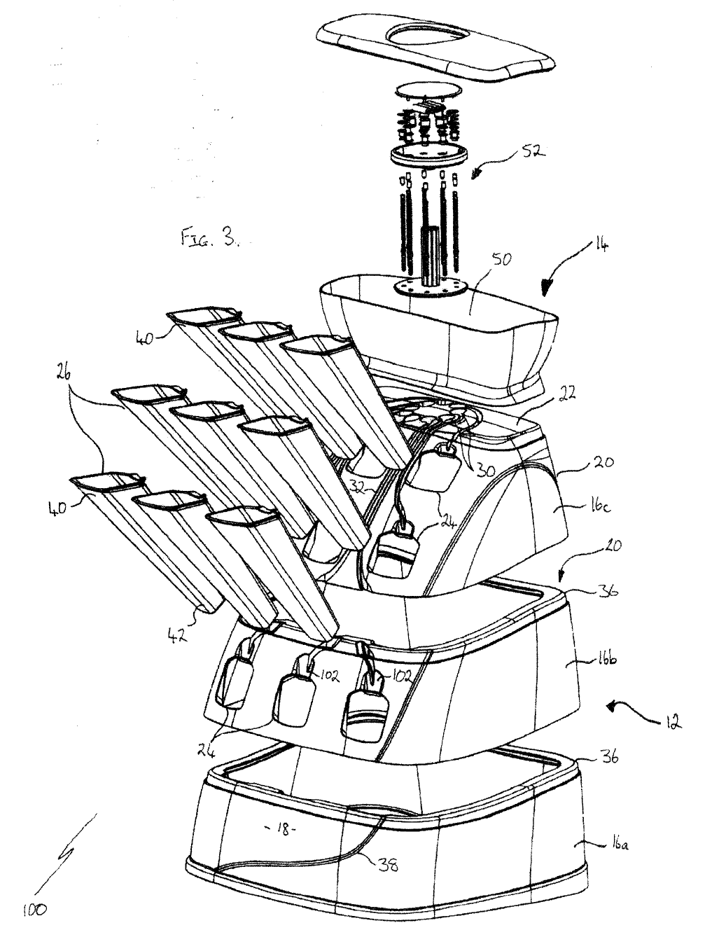

As illustrated in more detail in FIG. 3, the housing 12 of the apparatus shown in FIG. 1 consists of three interconnecting segments 16a, 16b and 16c. When interconnected, the segments 16 define an arcuate front face 18 and a back face 20.

The uppermost segment 16c also defines a top face 22 upon which the water feed apparatus 14 may be detachably mounted.

Segments 16b and 16c have a plurality of apertures 24 formed therein. Each aperture 24 is adapted to receive a plant receptacle 26.

The top face 22 has a plurality of shallow reservoirs 30 formed therein. The number of reservoirs 30 equals the number of apertures 24. Each reservoir 30 is also in fluid communication with each aperture 24 by way of conduits 32. The conduits 32 are integrally formed as part of the front face 18 of the housing 12.

The majority of conduits 32 includes at least one arcuate portion 34. In some instances, the conduit 32 defines a serpentine path from the reservoir 30 to its associated aperture 24. In each case, the conduit 32 is open to the atmosphere along its full length.

To ensure that the difference in quantity of fluid delivered to a reservoir 30 and the quantity of fluid delivered to a receptacle 26 received in the reservoir's 30 corresponding aperture 24 is minimal, the arcuate portions of each conduit 32 are banked.

As mentioned above, the segments 16 are able to interconnect to define the housing 12. To facilitate interconnection, with the exception of the uppermost segment 16c, each segment 16 includes a projection 36 that surrounds the periphery of the segment 16. The projection 36 is spaced from the periphery of the segment 16 by a distance equal to the thickness of the walls of the segments 16. In this manner, when the segments 16 are stacked one on top of the other, the projection 36 of the lower segment 16 abuts, and is encapsulated by, the walls of the upper segment 16. The tight abutment between projection 36 and segment 16 walls allows the apparatus 10 to be moved in a reasonably rugged fashion without detachment of the segments 16.

As a means of facilitating proper alignment of the segments 16 relative to one another, an alignment groove 38 is etched into the front face 18 of the housing 12. The alignment groove 38 extends across each segment 16 in a manner that only when the segments 16 have been properly connected and aligned will the alignment groove 38 be contiguous.

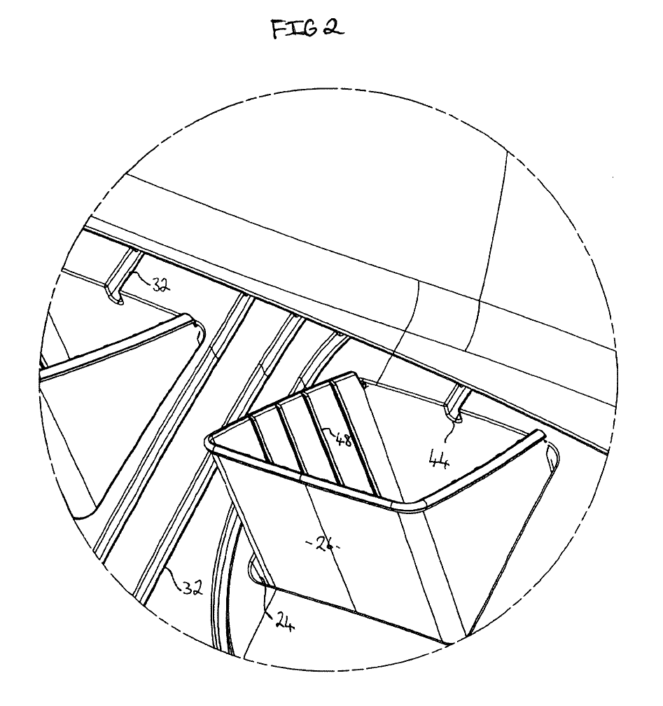

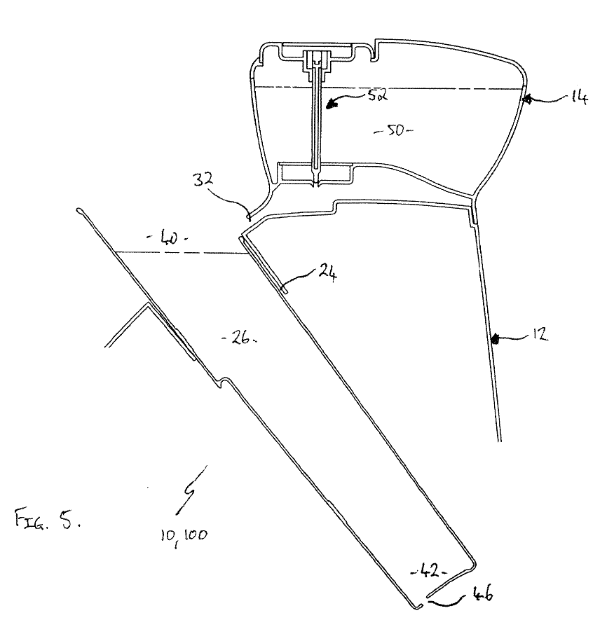

As shown in FIGS. 2 and 5, each plant receptacle 26 comprises an outwardly extending open end 40 and an inwardly extending root end 42. Located at the outwardly extending end 40 is an inlet port 44. The root end 42 of the plant receptacle 26 has a plurality of drainage holes 46 provided therein. The plant receptacle 26 is also provided with longitudinal ribs 48 on all sides excluding the side containing the inlet port 44.

As mentioned above, each plant receptacle 26 is adapted to be received within an aperture 24. Retention of the plant receptacle 26 in the aperture 24 is achieved by way of engagement of the outwardly extending end of the plant receptacle with at least a portion of the peripheral upper edge of the aperture 24. To further facilitate insertion and removal of the plant receptacle 26 from the aperture 24, the plant receptacle 26 tapers inwardly towards the root end 42. Correct reception is achieved when the inlet port 44 aligns with the conduit 32 associated with the aperture 24 into which the plant receptacle 26 is received.

When received within an aperture 24, the root end 42 of each plant receptacle 26 is encapsulated by the housing 12. Furthermore, when received within an aperture 24, the plant receptacle 26 is positioned in a downwardly inclined manner as shown in FIG. 5. This facilitates self-drainage through the drainage holes 46.

The water feed apparatus 14 comprises at least one fluid reservoir 50 and at least one dispenser 52. Each dispenser 52 is adapted to dispense fluid stored in one of the fluid reservoirs 50 to at least one shallow reservoir 30. As shown in FIGS. 1 and 3, the water feed apparatus 14 is adapted to be releasably connected to the top face 22 in such a manner that the shallow reservoirs 30 are not open to the general atmosphere. It should be appreciated that the specifics of the water feed apparatus 14 fall outside the scope of the present invention, but not beyond the abilities of the person skilled in the art, and therefore are not provided in specific detail here.

The invention will now be described in the context of its intended use.

Segment 16a is placed on a flat level surface to form a base segment 16. Intermediate segment 16b is then stacked on top of the base segment 16a. This stacking is achieved by first aligning the portions of the alignment groove 38 etched into their respective front faces 18. Once so aligned, the intermediate segment 16b is placed on the base segment 16a in such a manner that the projection 36 of the base segment 16a abuts, and is encapsulated by, the walls of the intermediate segment 16b. The top segment 16c is then stacked on top of the intermediate segment 16b in an identical fashion.

Plant receptacles 26 are then positioned in relation to the apertures 24 such that the inlet port 44 of each receptacle 26 aligns with the conduit 32 for the aperture 24 into which it is to be received. The plant receptacles 26 are then inserted into the apertures 24 until contact is made with at least one part of the peripheral upper edge of the aperture 24.

The water feed apparatus 14 is next attached to the housing 12. The attachment is formed in the same manner as the stacking of segments 16. However, the positioning of the water feed apparatus 14 relative to the housing 12 must be such that each dispenser 52 of the water feed apparatus 14 is aligned with one or more shallow reservoirs 30 formed in the top face 22. The end effect also means that the shallow reservoirs 30 are also cut off from the environment at large, resulting in a reduction in the potential for pollution or contamination of any fluid held therein for a period of time.

The fluid reservoir 50 of the water feed apparatus 14 is then filled with water or some other fluid. The fluid may include nutrients or other additives that assist in plant growth. The filling of the fluid reservoir 50 may be achieved manually (ie. by hand-filling the reservoir) or automatically (ie. by attaching the fluid reservoir to a mains tap).

Once filled the dispensers 52 operate to dispense, at predetermined times, a predetermined amount of fluid form the fluid reservoir 50 to each shallow reservoir 30. As the predetermined amount of fluid is always greater than the fluid capacity of the shallow reservoir 30, the fluid travels along the conduit 32 connecting the shallow reservoir 30 to an aperture 24. Gravity provides the momentum for the fluid to travel along the conduit 32 until such time as it reaches the aperture 24.

To ensure that there is minimal fluid loss as the fluid travels along the conduit 32, all arcuate portions 34 of the conduit 32 are banked at the outer curve. The water is then free to run up the side of the banked outer curve with minimal spillage compared to a conduit 32 having a uniform cross-section along its full-length.

Upon the fluid reaching the aperture 24 it is able to enter the internal area of the plant receptacle 26 due to the alignment of the inlet port 44 with the conduit 32.

Because the conduit 32 is open along its full length, the flow of fluid between the shallow reservoirs 30 and the inlet port 44 is observable by external parties. This provides two benefits in that any obstructions to the flow of fluid can be observed and, if obstructed, corrective action can easily be taken due to the open nature of the conduit 32 at the point of obstruction. The observable flow of fluid may also provide a pleasing visual effect to the observer.

In accordance with a second embodiment of the invention, where like numerals reference like parts, there is a plant cultivation apparatus 100. Plant cultivation apparatus 100 is identical to the first embodiment of the invention with the exception that the inlet port 44 is enlarged to a width matching a shallow trough 102. Each shallow trough 102 is interposed between a conduit 32 and aperture 24. In this manner, fluid flowing through the conduit 32 is able to fan out prior to reaching the inlet port 44. This allows a more even distribution of the fluid by the inlet port 44 along the width of the plant receptacle 26 than is otherwise obtained in the first embodiment of the invention.

This second embodiment is illustrated in more detail in FIG. 3.

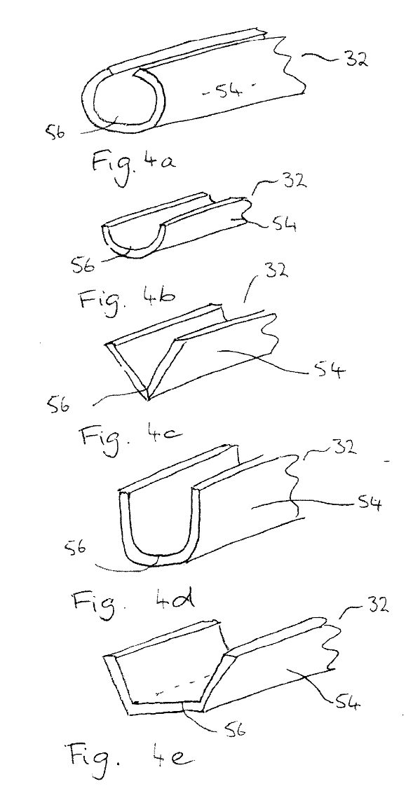

It should be appreciated by the person skilled in the art that the above invention is not limited to the embodiment described. In particular, the following modifications and improvements may be made without departing from the scope of the present invention:
The plant cultivating apparatus 10, 100 may be adapted to grow herbs, shrubs and trees.
The conduit 32 may take on a variety of cross-sectional configurations as illustrated in FIGS. 4a to 4e. Ideally, the cross-sectional configuration of the conduit 32 is a “V”-shaped configuration as shown in FIG. 4c due to the manufacturing efficiencies of such a configuration.
While the embodiments described above are the ideal solution, the same advantages can be achieved on a lesser scale by having the conduit 32 open along a portion of its length. In this manner, a visual assessment of the flow of water at the open portions of the conduit 32 (and at the point of delivery to the aperture 24) will identify any blockages within the enclosed portions of the conduit 32. One specific implementation of this alternative configuration involves enclosing each arcuate portion 34 of the conduit 32 thereby removing the need to bank an open conduit 32 at this position.
In other alternative configurations of the embodiment the conduits 32 may be moulded or pressed onto the housing 12. Yet other embodiments may see the conduits 32 affixed to the housing 12 in some manner, for example by a clip-on arrangement.
The root end 42 of the plant receptacle 26 may be permeable to liquids. Similarly, the housing 12 is preferably impermeable to moisture when the plant cultivation apparatus 10, 100 is used in a humid environment.
The housing 12 may be made out of such materials as fibreglass, plastics, metals (with a preference for stainless steel or aluminium) and terracotta.
While the embodiments shown in the Figures illustrate the apparatus 10, 100 with a 3×3 array configuration of receptacles 26, it should be appreciated by the person skilled in the art that other array configurations may be used. Furthermore, as the number of receptacles 26 for each row in the array are determined by the number of apertures 24 provided in a segment 16, it is possible that an apparatus 10, 100 may be configured such that the number of apertures 24 in one row (segment 16) differs from the number of apertures 24 in another row (segment 16). Yet further, the apertures 24 may be in differing alignment to one another in the array.
Intermediate segment 16b may be configured so as to allow other intermediate segments 16b of the same configuration to be stacked thereon. In this manner, the height of the plant cultivation apparatus 10, 100 may be increased. Furthermore, when dealing with plants that may grow larger than the ordinary spacing between one aperture 24 and the one above it, intermediate segments 16b having no apertures 24 provided therein may be used to further space apertures 24 from each other.
It is desirable that the impression given by the plant cultivation apparatus 10, 100 is a wall of plants. In this respect, alternative configurations not beyond the reach of the person skilled in the art may see the base segment 16a eliminated in favour of a wall mounting system for the intermediate 16b and top segments 16c.
The apparatus allows for the segments to be arranged on the front and back faces 18, 20 of the housing 12. In small size arrangements of the apparatus 10, 100, this arrangement may require segments 16 to be stacked such that the apertures 24 alternate between the front and back faces 18, 20 to avoid contact between the downwardly inclined nature of the plant receptacles 26 when received within such apertures 24. Of course, in larger size arrangements, apertures 24 may be provided on both the front and back faces 18, 20 without need to address this problem.
The plant receptacles 26 may be integrated with the apertures 24.
The upper portion of the conduit 32 in each segment 16 may be of slightly expanded width compared to the rest of the conduit 32. In this manner, the slight expansion in width compensates for any minor misalignments in the stacking of the segments 16 in a way that such misalignments do not result in a loss of fluid.
The conduit 32 may have a smooth base 56 and rough sides 54 or a rough base 56 and smooth sides 54. In this manner, the difference in surface tension between the base 56 and sides 54 can allow for the fluid to be further directed as it flows down the conduit 32.
The conduit 32 may be banked in a manner that the banked portion of the conduit 32 protrudes from the front face of the housing. However, for aesthetic considerations, the conduit 32 may also be banked in a manner so as to be flush with the front face of the housing 12.
The housing 12 may include a sump (not shown) for receiving liquid that has drained from plants contained in the plant receptacles 26. The sump is ideally positioned below the plurality of receptacles 26. Piping means operatively connect the sump with the fluid reservoir 50 to allow for recycling of the liquid to the reservoir 50. The apparatus 10, 100 may equally be provided with a liquid filter operatively mounted between the sump and the reservoir 50 for filtering solids from the liquid being recycled to the fluid reservoir 50 from the sump.
The apparatus 10, 100 may include a heater adapted to heat the fluid in the fluid reservoir 50 or the fluid in the shallow reservoirs 30 to a predetermined temperature. Alternatively, a heater may be included and positioned within the housing 12 in such a manner as to increase the effective humidity of the housing 12.
The water feed apparatus 14 may be omitted. In its place, the shallow reservoirs 30 may receive fluid directly by the user.
The shallow reservoirs 30 may be replaced by a single central reservoir. The single central reservoir then acts as the sole supplier of fluid for the conduits 32, and thereby, the plant receptacles 26.
The apertures 24 may be configured so as to receive the plant receptacles 26 at a slightly recessed position. By positioning the plant receptacle 26 at a slightly recessed position within the aperture 24, the end of the conduit 32 can be elevated relative to the plant receptacle 26. This then relieves the need to have an inlet port 44 in the plant receptacle 26 as fluid can directly reach the plant receptacle 26.
The segments 16 may be further configured to include an array of apertures 24.
The longitudinal ribs 48 may be provided on all sides of the plant receptacle 26.
The segments 16 may be interconnected by other means to that described above. For instance a retainer and clip system may be used to interconnect the segments 16.

It should be further appreciated by the person skilled in the art that the features described above, where not mutually exclusive, can be combined to form yet further embodiments of the invention.

What is claimed:

1. A plant cultivation apparatus comprising:
a housing including at least one receptacle arranged to receive and support a corresponding number of plants;
at least one conduit attached to the housing connecting each of the receptacles with a reservoir, each of the at least one conduit connecting a single receptacle of the at least one receptacles with the reservoir; and
wherein at least a portion of each conduit is open to the atmosphere.

2. A plant cultivation apparatus according to claim 1, wherein the full length of the conduit is open to the atmosphere.

3. A plant cultivation apparatus according to claim 1, wherein the at least one conduit includes one or more banked arcuate portions.

4. A plant cultivation apparatus according to claim 3, wherein the arcuate portion is positioned in such a manner that the conduit is flush with a face of the housing.

5. A plant cultivation apparatus according to claim 1, wherein the at least one conduit includes one or more arcuate portions, and each arcuate portion is closed to the atmosphere.

6. A plant cultivation apparatus according to claim 1, wherein each plant receptacle includes an open end and a root end positioned in a downwardly inclined manner such that the root end is lower than the open end in normal orientation of the plant cultivation apparatus.

7. A plant cultivation apparatus according to claim 1, wherein each plant receptacle includes a root end and drainage holes are provided in the root end to assist self drainage of the receptacle.

8. A plant cultivation apparatus according to claim 1, wherein the housing includes at least one aperture into which a plant receptacle may be detachably received.

9. A plant cultivation apparatus according to claim 1, wherein each plant receptacle includes a root end permeable to liquids.

10. A plant cultivation apparatus according to claim 1, wherein the housing is impermeable to moisture.

11. A plant cultivation apparatus according to claim 1, wherein the housing comprises a plurality of interconnecting, detachable segments.

12. A plant cultivation apparatus according to claim 11, wherein each detachable segment includes an alignment groove inscribed thereon to facilitate correct orientation and connection of the detachable segments.

13. A plant cultivation apparatus according to claim 11, wherein, at the point of connection between a first lower segment and a second upper segment, a portion of the conduit provided in the first lower segment at the point of interconnection includes an expanded cross-section relative to the remainder of the conduit.

14. A plant cultivation apparatus according to claim 1, wherein the housing includes at least one partially convex face.

15. A plant cultivation apparatus according to claim 1, further comprising a shallow trough interposed between each conduit and its associated plant receptacle.

16. A plant cultivation apparatus according to claim 1, wherein each conduit includes a base and side walls, the base having a smooth profile and the side walls having a rough profile.

17. A plant cultivation apparatus according to claim 1, wherein each conduit includes a base and side walls, the base having a rough profile and the side walls having a smooth profile.

18. A plant cultivation apparatus according to claim 1, wherein the conduit has a V-shaped cross-section.

19. A plant cultivation apparatus according to claim 1, wherein the fluid moves along the conduit from the reservoir to each plant receptacle by virtue of gravity.

20. A plant cultivation system comprising:
a plant cultivation apparatus according to claim 1; and
a water feed apparatus;
wherein the water feed apparatus comprises at least one fluid reservoir and at least one dispenser, the water feed apparatus positioned relative to the plant cultivation apparatus such that each dispenser is operable to dispense fluid from the fluid reservoir to at least one of the reservoirs.

21. A plant cultivation system according to claim 20, further comprising a sump arranged to collect fluid that drains from the receptacles.

22. A plant cultivation system according to claim 21, wherein the sump is further configured to recycle fluid back to the fluid reservoir.

23. A plant cultivation system according to claim 20, further comprising a heater positioned so as to heat the fluid stored in the fluid reservoir.

24. A plant cultivation system according to claim 20, further comprising a heater positioned so that the heat generated thereby increases the general humidity surrounding the plant cultivation system.
